(19) United States
(12) Patent Application Publication
(10) Pub. No.: US 2006/0267511 A1
(43) Pub. Date: Nov. 30, 2006

(54) Start-Up Supervision Circuit

(76) Inventor: Bengt Berg, Solna (SE)

Correspondence Address: BAKER BOTTS, L.L.P., 98 SAN JACINTO BLVD., SUITE 1500, AUSTIN, TX, 78701-4039, US

(21) Appl. No.: 11/380,323

(22) Filed: Apr. 26, 2006

Related U.S. Application Data
(63) Continuation of application No. PCT/SE04/01556, filed on Oct. 27, 2004.

(30) Foreign Application Priority Data
Oct. 30, 2003 (SE) 0302863-6

(51) Int. Cl. H05B 39/04

(52) U.S. Cl. 315/209 R

(57) ABSTRACT

An arrangement and a method in an integrated circuit include a start signal generating circuit provided to generate a start signal, when a supply voltage has reached a stable operating voltage level, to operating circuits in the integrated circuit at start-up of the integrated circuit. The arrangement has a detection circuit connected to the start signal generating circuit and provided to detect when the supply voltage has reached a first voltage level and to order the start signal generating circuit to generate a start signal when a second voltage level has been reached.

### CROSS-REFERENCE TO RELATED APPLICATION

This application is a continuation of co-pending International Application No. PCT/SE2004/001556 filed Oct. 27, 2004, which designates the United States, and claims priority to Swedish application number SE0302863-6 filed Oct. 30, 2003.

### TECHNICAL FIELD

The present invention relates to an arrangement for providing a start signal during start-up of a circuit and a method therefore. More specifically the present invention relates to an arrangement for providing a start signal in an integrated circuit when a stable supply voltage has been established and a method therefore.

### BACKGROUND

When power is applied to a circuit it will take a certain time before the supply voltage reaches a stable operating level. During this time it is preferable not to have any normal operation of these circuits, since the supply voltage level is uncertain and thus the proper operation of specific circuits cannot be guaranteed.

Moreover, the rise of the supply voltage may have different forms depending on for instance the source of the power. It may for instance be a slow rise, which eventually reaches a stable operating voltage level, or it may be a quick rise with some extent of ringing. In this case also the ringing of the supply voltage may cause problems for the circuits to which the power is applied.

Consequently, it is important not to start the operation of the circuitry until a stable supply voltage has been established. This can be achieved by providing a start signal to the circuitry. Thus, the operation of the circuitry is delayed until the start signal is received. It should be noted that some specific types of initial operation might be allowed before the stable operating supply voltage has been established such as resetting logic circuitry.

The delay mentioned above is of course unwanted in that it delays the wanted function of the circuits. It is therefore important to keep this delay as short as possible, while at the same time not issue the start signal before a stable supply voltage has been established.

Furthermore, the actual voltage level supplied to the integrated circuit may vary between specific tolerances. That is, in one installation the supplied voltage may for instance be 29 volt and in another 31 volt. Thus, it may be complicated to determine when the actual operating voltage has been reached at start-up.

A further complication is that such a start-up signal generating circuit need to be internal to the circuitry receiving the start-up signal and cannot relate to any external reference voltages.

### SUMMARY

It is a main object of the present invention to provide such an apparatus and a method that at least alleviates the above problems.

It is in this respect a particular object of the invention to provide such an apparatus and a method that issues a start-up signal to a circuitry in an integrated circuit when a stable operating supply voltage has been established.

These objects among others are, according to a first aspect of the present invention, attained by an arrangement in an integrated circuit comprising a start signal generating circuit provided to generate a start signal when a supply voltage has reached a stable operating voltage level to operating circuits in said integrated circuit at start-up of the integrated circuit. The arrangement comprises a detection circuit connected to said start signal generating circuit and provided to detect when said supply voltage has reached a first voltage level. The detection circuit orders said start signal generating circuit to generate a start signal when a predetermined criteria has been reached after said voltage level has been reached.

The above objects among others are, according to a second aspect of the present invention, attained by a method for providing a start-up signal in an integrated circuit comprising the steps of: detecting when a supply voltage has reached a first voltage level, and issuing a start-up signal after a predetermined criteria has been reached.

According to a preferred embodiment said predetermined criteria is the criteria that the variation of said supply voltage in relation to a mean value is below a threshold value. Thereby, a supply voltage having heavy ringing, will be allowed time to stabilize before the start-up signal is generated.

According to a preferred embodiment the predetermined criteria is reaching a second voltage level and said second voltage level is said stable operating voltage level.

According to a preferred embodiment said predetermined criteria is a predetermined time after said first voltage level has been reached.

According to another preferred embodiment the detection circuit comprises a voltage measuring circuit provided to measure said supply voltage level, and detect when said supply voltage reaches said first voltage level, and a time delay circuit connected to said voltage measuring circuit and to said start signal generating circuit and provided to delay the generation of said start signal by a predetermined time after the detection of said supply voltage reaching said first voltage level.

According to another preferred embodiment the arrangement is connectable to a capacitor having a capacitance determining said predetermined time.

According to another preferred embodiment the capacitor is external to said integrated circuit so that a user of said integrated circuit may set said predetermined time by selecting a suitable capacitance for said external capacitor.

According to another preferred embodiment the first voltage level is a fraction of said stable operating voltage level.

According to another preferred embodiment the detection of reaching a first voltage level and issuing of said start-up signal is performed by circuitry in said integrated circuit and said predetermined time is set by the capacitance of an capacitor and where said capacitor is external to said integrated circuit.

According to another preferred embodiment the start-up signal is a pulse and the duration of said pulse is determined by said capacitance.

Further characteristics of the invention and advantages thereof will be evident from the following detailed description of embodiments of the invention.

### BRIEF DESCRIPTION OF THE DRAWINGS

The present invention will become more fully understood from the detailed description of embodiments of the present invention given herein below and the accompanying FIGS. 1-2, which are given by way of illustration only, and thus are not limitative of the present invention.

FIG. 1 is a schematic circuit diagram of a preferred embodiment according to the invention.

FIG. 2a and FIG. 2b are two schematic graphs over application of supply voltage.

### DETAILED DESCRIPTION

In the following description, for purposes of explanation and not limitation, specific details are set forth, such as particular techniques and applications in order to provide a thorough understanding of the present invention. However, it will be apparent to one skilled in the art that the present invention may be practiced in other embodiments that depart from these specific details. In other instances, detailed descriptions of well-known methods and apparatuses are omitted so as not to obscure the description of the present invention with unnecessary details.

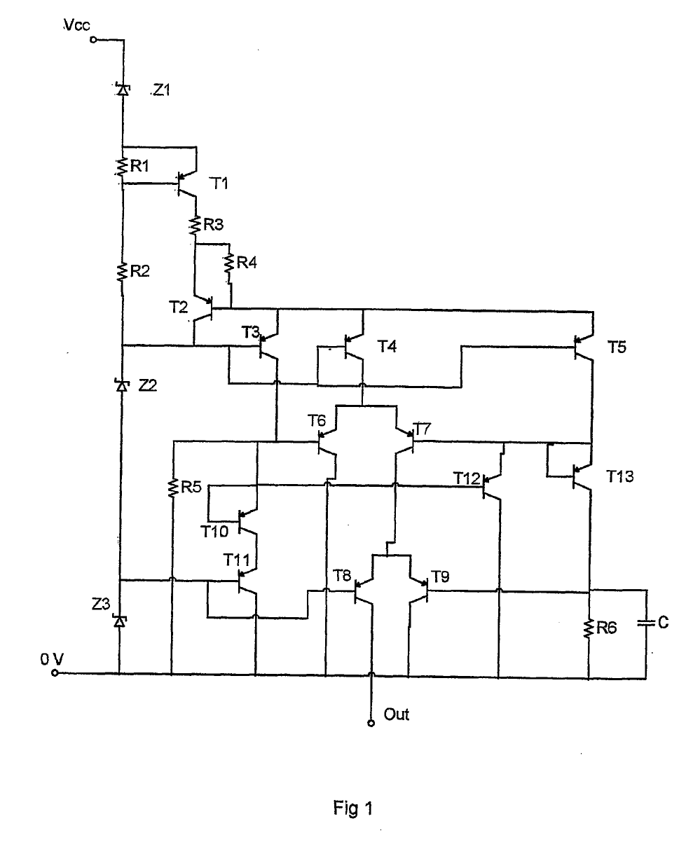

FIG. 1 is a schematic circuit diagram of a preferred embodiment according to the invention for implementation in an integrated circuit.

The circuit detects Vcc and issues a start-up pulse when a first voltage level has been reached. This first voltage level is a fraction of the Vcc operating voltage level and is set so that the first voltage level is guaranteed to be reached given due consideration to supply voltage tolerances.

The circuit comprises first, second and third Zener diodes Z1, Z2 and Z3, where Z3 is connected to ground and to Z2. Z2 is connected to Z1 through a voltage divider comprising first and second resistors R1 and R2. When the voltage between resistors R1 and R2, which are connected to the base of a transistor T1, reaches the level where T1 starts to conduct, the circuit is operational.

A resistor R3, connected to the collector on T1, limits the current through T1. The resistor R3 is further connected to a resistor R4 and a transistor T2. The resistor R4 and the transistor T2 operates as a simple constant current provider. The current goes primarily through the resistor R4, but when the voltage over the resistor R4 reach a level when the transistor T2 starts to conduct, the rest of the current will go through the transistor T2 and further through the second and third Zener diodes Z2 and Z3.

The constant current through the resistor R4 is further divided by transistors T3, T4 and T5, respectively. The transistors T3, T4 and T5 operate as constant current generators.

The transistor T3 feeds current through transistors T10 and T11 and forces the base of a transistor T6 to be two diode voltage drops above the base of a transistor T8. The voltage to the base of the transistor T8 is Z3 above zero voltage.

The transistor T4 feeds current to transistors T6, T7, T8 and T9, which operate partly as comparators and partly as logic.

The transistor T5 operates as a current generator to a capacitor C. The capacitor C is also connected to the base of the transistor T9. The base of the transistor T7 is one diode voltage drop higher than the base of T9 through a diode-connected transistor T13.

At the start moment, when power is applied, a resistor R6, connected in parallel to the capacitor C, holds zero volts over C. The current through the transistor T4 will then pass through the transistor T7, since the base of the transistor T7 is below the base of the transistor T6, and further through the transistor T9 since the base of the transistor T9 is lower than the base of the transistor T8. There will thus be no current from the collector on the transistor T8. This situation prevails until the current from the transistor T5 has charged the capacitor C so much that the base of the transistor T9 is above the base of the transistor T8. This occurs when the voltage over the capacitor C is higher than the voltage over the Zener diode Z3.

When this occurs the current from the transistor T7 changes over from the transistor T9 to flow through the collector of the transistor T8 producing the up-flank of the start-pulse. The transistor T5 continues to charge the capacitor C and when the voltage has increased with yet one diode voltage drop, the base of the transistor T7 will be higher than the base of the transistor T6 and the current from the transistor T4 will go through the transistor T6 and thus seize to arrive at the collector of the transistor T8 providing the down-flank of the start-pulse. The start-pulse has thus ended.

The voltage over the capacitor C still continues to increase through the charging by T5. When the voltage over the capacitor has increased with yet one diode voltage drop a clamp transistor T12 will prevent further increase of the voltage over the capacitor C. The start-up generating circuit has thus completed its task and nothing further will occur until the voltage Vcc disappears at which time the resistor R6 will discharge the capacitor C and the circuit is ready to generate another start-pulse.

A resistor R5, which is a high resistance resistor, is provided to keep the circuit firmly shutdown when the circuit is not in use.

The described circuit diagram is preferably implemented in an integrated circuit and mounted in a conventional capsule for integrated circuits apart from the capacitor C. The capacitor is preferably connectable to the capsule whereby it is possible for a user to select the duration of the pulse as well as the time delay from the detection of the first voltage to the start of generation of the start pulse.

The Zener diode Z1 is not necessary for the function of the circuit and is only provided to raise the voltage level for the first voltage level. The circuit will be operational, at a first estimation, when:

$$Vcc > V ( Z 1 ) + V ( Z 2 ) + V ( Z 3 ) + \frac{R 1 + R 2}{R 1} * VBE ( T 1 )$$

where V(x) is the voltage across the Zener diode x and VBE(x) is the base-emitter voltage of the transistor x.

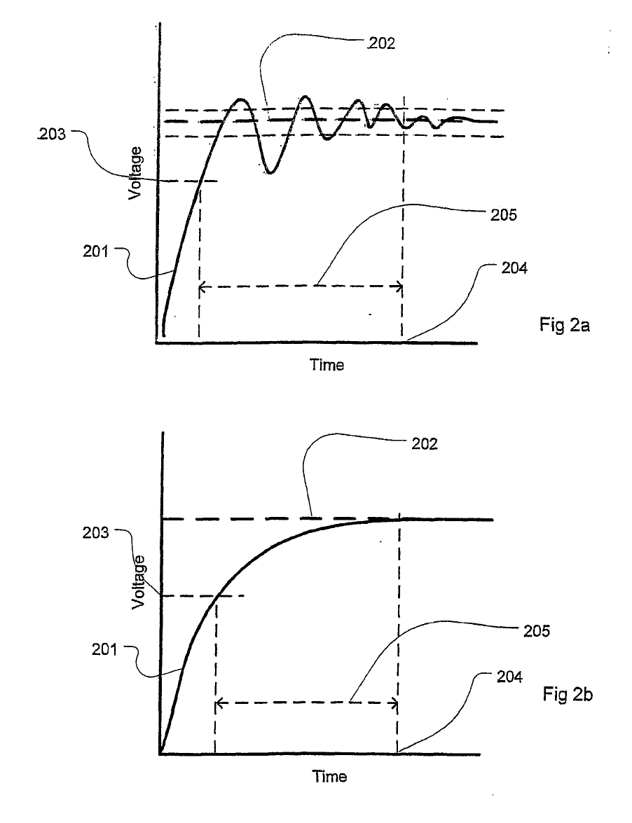

FIG. 2a and 2b are two different graphs over the rise of supply voltage 201. FIG. 2a disclose a situation where a rapid increase in supply voltage results in a substantial ringing effect, that is, the supply voltage rises above and falls below the operating level 202 several times before stabilizing. In this situation the arrangement according to the invention may wait a predetermined time, after the first voltage level 203 has been reached, before issuing the start-up signal 204 or, alternatively, may use as a criteria that the variation of the supply voltage 201 should be below the indicated thresholds.

FIG. 2b disclose a situation where the supply voltage 201 increases rapidly in the beginning but where the increase declines so that no ringing occurs. In this situation the criteria used is that a predetermined time 205 has lapsed from the time where the supply voltage reached the first voltage level 203 to when the start-up signal is issued 204.

It will be obvious that the invention may be varied in a plurality of ways. For instance could an arrangement be devised where a user through external components also could select the first voltage. Such variations are not to be regarded as a departure from the scope of the invention. All such modifications as would be obvious to one skilled in the art are intended to be included within the scope of the appended claims.

What is claimed is:

1. An arrangement in an integrated circuit comprising a start signal generating circuit provided to generate a start signal to operating circuits in said integrated circuit at start-up of the integrated circuit when a supply voltage has reached a stable operating voltage level, and a detection circuit connected to said start signal generating circuit and provided to detect when said supply voltage has reached a first voltage level and to order said start signal generating circuit to generate a start signal when said first voltage level and an additional predetermined criteria has been reached, wherein said additional predetermined criteria is the criteria that the variation of said supply voltage in relation to a mean value is below a threshold value.

2. An arrangement as claimed in claim 1, wherein said detection circuit comprises a voltage measuring circuit for measuring said supply voltage level.

3. An arrangement as claimed in claim 1, wherein said first voltage level is a fraction of said stable operating voltage level, set so that said first voltage level is reached given due consideration to supply voltage tolerances.

4. An arrangement as claimed in claim 1, wherein said arrangement further comprises a capacitor.

5. An arrangement as claimed in claim 4, wherein said start signal is a pulse, and the duration of said pulse is determined by said capacitor.

6. An arrangement as claimed in claim 1, further comprising a high resistance resistor provided for keeping the circuit shutdown when not in use.

7. A method for providing a start-up signal in an integrated circuit comprising the steps of:
detecting when a supply voltage has reached a first voltage level,
issuing a start-up signal when said first voltage level and an additional predetermined criteria, wherein said additional predetermined criteria is that the variation of said supply voltage, in relation to a mean value, is below a threshold.

8. An arrangement in an integrated circuit comprising:
a start signal generating circuit operable to generate a start signal to operating circuits in said integrated circuit at a start-up of the integrated circuit when a supply voltage has reached a stable operating voltage level,
a detection circuit connected to said start signal generating circuit and operable to detect when said supply voltage has reached a first voltage level and to order said start signal generating circuit to generate a start signal when said first voltage level has been reached and the variation of said supply voltage in relation to a mean value is below a threshold value.

9. An arrangement as claimed in claim 8, wherein said detection circuit comprises a voltage measuring circuit for measuring said supply voltage level.

10. An arrangement as claimed in claim 8, wherein said first voltage level is a fraction of said stable operating voltage level, set so that said first voltage level is reached given due consideration to supply voltage tolerances.

11. An arrangement as claimed in claim 8, wherein said arrangement further comprises a capacitor.

12. An arrangement as claimed in claim 11, wherein said start signal is a pulse, and the duration of said pulse is determined by said capacitor.

13. An arrangement as claimed in claim 8, further comprising a high resistance resistor provided for keeping the circuit shutdown when not in use.
